(19) United States
(12) Patent Application Publication
(10) Pub. No.: US 2022/0362705 A1
(43) Pub. Date: Nov. 17, 2022

(54) Air Purification System

(71) Applicant: Mauricio Nicola Alvarez Stabile, Etobicoke (CA)

(72) Inventor: Mauricio Nicola Alvarez Stabile, Etobicoke (CA)

(21) Appl. No.: 17/321,298

(22) Filed: May 14, 2021

(51) Int. Cl. B01D 46/42; B01D 46/00; B01D 46/10; F24F 8/10

(52) U.S. Cl. CPC B01D 46/4227; B01D 46/4254; B01D 46/0002; B01D 46/008; B01D 46/10; F24F 8/10; B01D 2265/024; B01D 2279/50

(57) ABSTRACT

An air purification system for installation over a vent. The air purification system includes a housing including a rear-section having a filter-compartment; and a front-section having a set of horizontal-slats (louvers). Further, the air purification system includes a filter-receptacle removably received within the filter-compartment and configured to removably house a filter-means such as a HEPA filter. The filter-receptacle can be lowered from the housing so that a user may change or clean the filter-means, and then raised back into the housing for use. The air purification system is useful for filtering particles such as pet hair, pollen, mold, viruses, bacteria, etc. from air vented through the vent, therefore purifying air in a building.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of air systems of existing art and more specifically relates to an air purification system for a vent.

### RELATED ART

A make-up air system is an air system that pulls in fresh air from outside a building to inside the building and circulates the air through rooms and common areas of the building. Make-up air systems are typically recommended and used in buildings with a great need for ventilation and improved air quality. Particularly, make-up air systems are used in commercial buildings such as office buildings and hotels; and shared accommodation buildings such as condominiums and apartment buildings.

Because these buildings generally have capacity for hundreds to thousands of people it is of great importance to be able to supply high air quality and substantially reduce the incidence of pollen, pet dander, pet hair, mold, and pathogenic matter in the air circulated within the building. This is of particular importance in times of epidemic and pandemic to minimize the spread of disease. However, make-up air systems do not currently have an acceptable means of filtering air being circulated through the building. As such, a suitable solution is desired.

### SUMMARY OF THE INVENTION

In view of the foregoing disadvantages inherent in the known air system art, the present disclosure provides a novel air purification system. The general purpose of the present disclosure, which will be described subsequently in greater detail, is to provide a system for installation in a vent of a building to filter air before being vented into a room of the building.

An air purification system is disclosed herein. The air purification system may be configured for installation over a vent. The vent may be integral to a wall surface in a room of a building. The vent may be configured to vent moving airflow conveyed from ductwork in an air system of the building. The air purification system may include a housing including a top-side opposite a bottom-side, a right-side opposite a left-side and a front-side opposite a rear-side all relative to the wall surface. The front-side may be substantially open and the rear-side may be configured for placement over the vent and thus configured to receive the moving airflow.

The housing may be defined by a rear-section relative to the rear-side and a front-section relative to the front-side. The rear-section may include a filter-compartment configured to removably house a filter-means, the filter-means configured to filter particles from the moving airflow. The front-section may include a set of horizontal-slats. Each of the horizontal-slats may be angled to let filtered airflow (filtered by the filter-means) through the front-side of the housing and into the room of the building. Further, a movement-mechanism may be provided. The movement-mechanism may be in communication with the filter-compartment and configured to selectively raise and lower the filter-means from bottom-side of the housing.

According to another embodiment, a method of use for an air purification system is also disclosed herein. The method of use includes providing the air purification system as above, installing the filter-means in the filter-compartment of the rear-section; and installing the housing over the vent, the rear-side being placed thereover to receive the moving airflow such that the filter-means is able to filter the moving airflow before being vented into the room.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an air purification system, constructed and operative according to the teachings of the present disclosure.

FIG. 1 is a front side perspective view of the air purification system being installed over a vent, according to an embodiment of the disclosure.

FIG. 2 is a side view of the air purification system of FIG. 1 illustrating a left-side of the housing being removed and showing a filter-compartment, a filter-receptacle and a filter-means within a rear-section of the housing, according to an embodiment of the present disclosure.

FIG. 3 is a top view of the air purification system of FIG. 1 illustrating a top-side of the housing being removed and showing a movement-mechanism, according to an embodiment of the present disclosure.

FIG. 4 is a bottom view of the air purification system of FIG. 1 illustrating the filter-compartment, according to an embodiment of the present disclosure.

FIG. 5A is a rear view of the air purification system illustrating the filter-receptacle, according to an embodiment of the present disclosure.

FIG. 5B is a rear view of the air purification system of FIG. 5A illustrating the filter-receptacle housing the filter-means, according to an embodiment of the disclosure.

FIG. 6 is a side front perspective view of the air purification system illustrating the filter-receptacle and an exploded view of a roller-assembly, according to an embodiment of the disclosure.

FIG. 7 is a front view of the air purification system of FIG. 6 illustrating the roller-assembly relative to a horizontal-axis, according to an embodiment of the present disclosure.

FIG. 8 is a front view and a close-up of a section thereof of the air purification system of FIG. 7 illustrating the filter-receptacle being partially removed from the housing, and the roller-assembly including at least one spring attached to the filter-receptacle for lowering and raising the filter-receptacle, according to an embodiment of the present disclosure.

FIG. 9 is a front perspective view of the air purification system illustrating a lock-mechanism and a key-means, according to an embodiment of the present disclosure.

FIG. 10 is a front perspective view of the air purification system illustrating the lock-mechanism and the key-means, according to another embodiment of the present disclosure.

FIG. 11A is a front perspective view of the air purification system illustrating the lock-mechanism in a locked-position, according to another embodiment of the present disclosure.

FIG. 11B is a front perspective view of the air purification system illustrating the lock-mechanism of FIG. 11A in an open-position, according to another embodiment of the present disclosure.

FIG. 12 is a flow diagram illustrating a method of use for the air purification system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to an air purification system and more particularly to an air purification system for installation over a vent as used to improve air quality in a building. Generally, disclosed is an improved vent louver system which may include a housing having horizontal slats disposed on a front-side thereof and a rear-side for installation over a vent. The vent louver system may further include a filter safety cage. A filter, preferably a HEPA filter, may be removably placed within the filter safety cage and configured to filter particles such as viruses, pet hair, smoke, dust, etc. from air vented through the vent. The filter safety cage may include a roller rod and ratchet combination for safely lowering and raising the filter safety cage from the housing to change the filter.

The filter safety cage may include an aluminum L frame attached to a thin metal rope/metal rod which is connected to the ratchet. Further, the filter safety cage may include a lock mechanism. The lock mechanism may consist of the filter safety cage including a keyhole, and a handheld key or an extension pole including a key for mating with the keyhole. The extension pole may include a handle at one end, and the key at an opposite end. The handheld key may include a body having a key at one end. Further, the key may include an LED light for illuminating the keyhole on the filter safety cage.

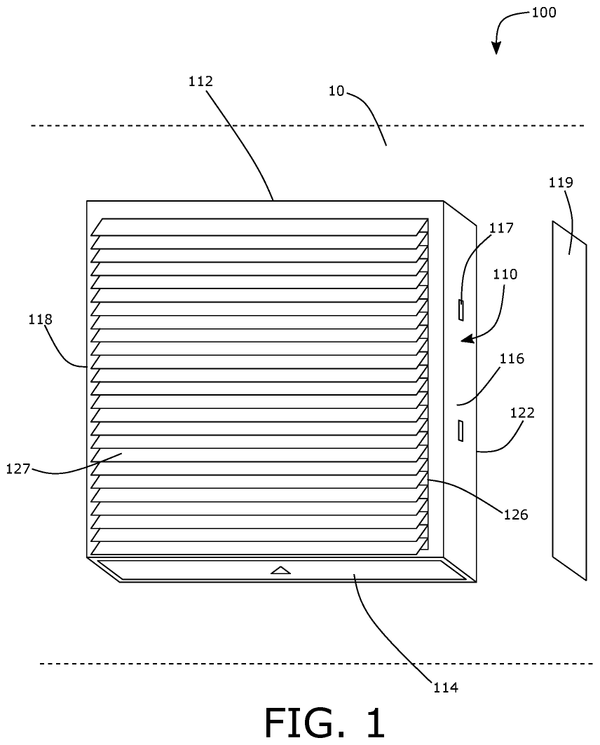

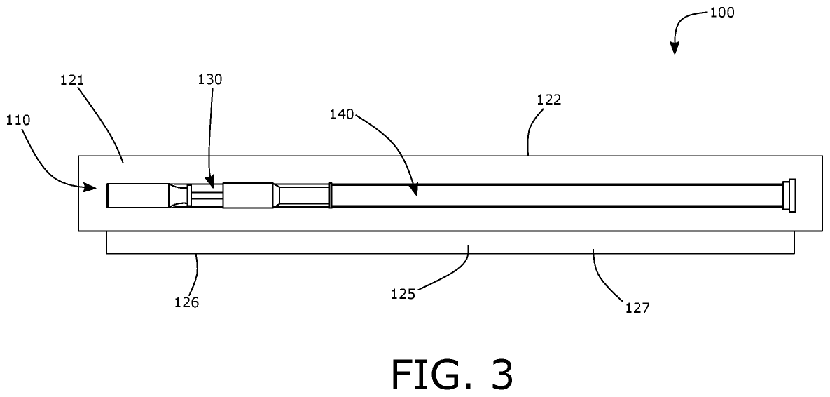

Referring now more specifically to the drawings by numerals of reference, there is shown in FIGS. 1-11B, various views of an air purification system 100.

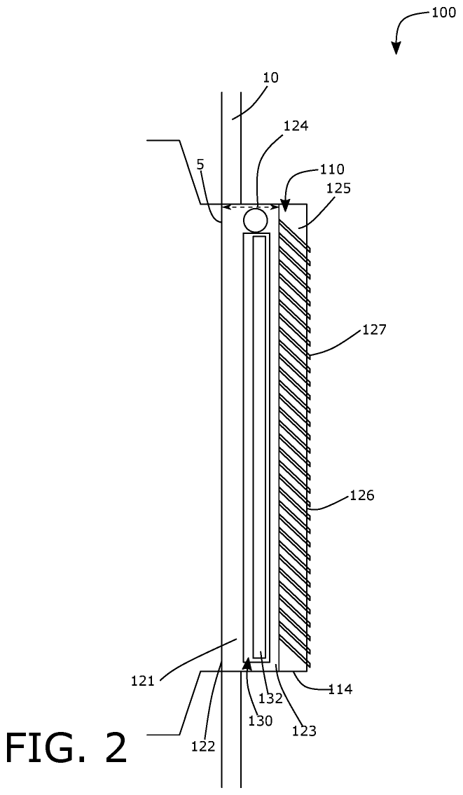

The air purification system 100 may include a housing 110 and a movement-mechanism 140. As shown in FIG. 2, the air purification system 100 may be configured for installation over a vent 5. The vent 5 may be integral to a wall surface 10 (shown in FIGS. 1-2) in a room of a building and configured to vent moving airflow conveyed from ductwork in an air system of the building. In some embodiments, the air system may be a makeup air system. Further, whilst the vent 5 being integral to the wall surface 10 is the exemplary embodiment in the present disclosure, it is contemplated that the air purification system 100 may be used with vents in other surfaces such as roofs, ceilings, floors, and the like.

As FIG. 1 illustrates, the housing 110 may include a top-side 112 opposite a bottom-side 114, a right-side 116 opposite a left-side 118 and a front-side 126 opposite a rear-side 122 all relative to the wall surface 10. The front-side 126 may be substantially open and the rear-side 122 may be configured for placement over the vent 5 and thus configured to receive the moving airflow. In some embodiments, the housing 110 may further include at least one removable cover 119 for covering at least one of the top-side 112, the bottom-side 114, the right-side 116 and the left-side 118 of the housing 110. To facilitate attachment, both the desired side (112, 114, 116, 118) and one side of the removable cover 119 may include at least one clip 117.

As shown in FIG. 2, the housing 110 may be defined by a rear-section 121 relative to the rear-side 122 and a front-section 125 relative to the front-side 126. In some embodiments, the front-section 125 and the rear-section 121 of the housing 110 may be separable. For example, the front-section 125 and the rear-section 121 may be separate sections that are attached together to form the housing 110. In other embodiments, the housing 110 may be one piece. The rear-section 121 may include a filter-compartment 123 configured to removably house a filter-means 132. As shown in FIGS. 1-2, the front-section 125 may include a set of horizontal-slats 127 covering the front-side 126 of the housing 110. Each of the horizontal-slats 127 may be angled to let (filtered) airflow through the front-side 126 of the housing 110 and into the room of the building. In some embodiments, each slat from the set of horizontal-slats 127 may be selectively adjustable. For example, to prevent 5 airflow into the room, the set of horizontal slats 127 may be closed.

The rear-section 121 may include the filter-compartment 123 configured to removably house the filter-means 132. The filter-means 132 may be configured to filter particles from the moving airflow before it passes through the set of horizontal-slats 127 (and into the room of the building). The filter-means 132 may be configured to remove a substantial number of particles such as dust, pollen, mold, bacteria, viruses, etc. from the moving airflow. For example, the filter-means 132 may be configured to remove at least 99.97% of particles having a size of 0.3 microns (and larger). As such, preferably, the filter-means 132 may be a High-Efficiency Particulate Air (HEPA) filter. The HEPA filter may be easily cleanable and/or disposable such that the HEPA filter may be easily replaced. The filter-means may be provided with the air purification system 100 or may be a standard filter-means, HEPA filter, etc.

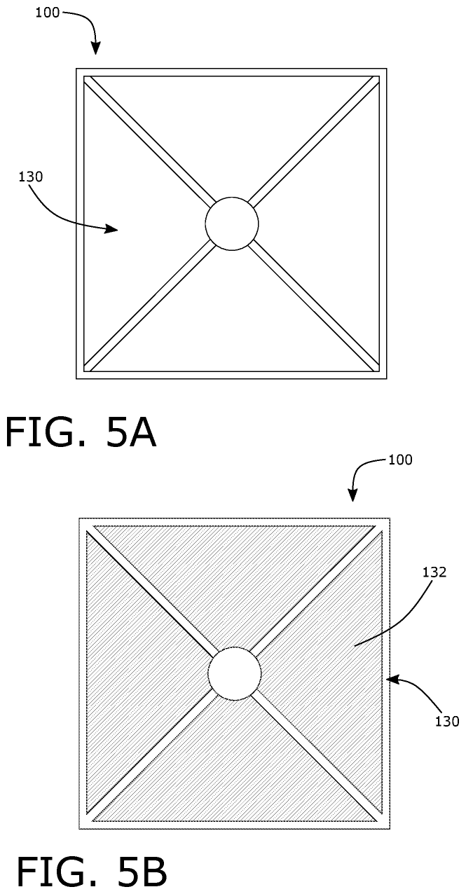

As shown in FIGS. 2, and 5A-10, the air purification system 100 may further include a filter-receptacle 130 removably received within the filter-compartment 123. The filter-receptacle 130 may be configured to removably house the filter-means 132, and both the filter-receptacle 130 and the filter-means 132 (housed within the filter-receptacle 130) may be removably housed within the filter-compartment 123. Preferably, the filter-receptacle 130 may be a cage. The cage may be made from a substantially metal material, such as aluminum and may include a sturdy frame. As shown in FIGS. 5A-5B, the frame may be fixed to a top, bottom, sides and rear of the filter-receptacle 130 to support the filter-means 132 housed therein. To accommodate the filter-means 132, the rear-section 121 may include a rear section-depth 124 of between 0.75-1 inch.

The movement-mechanism 140 may be in communication with the filter-compartment 123 and configured to selectively raise and lower the filter-means 132 from the bottom-side 114 of the housing 110. Preferably, the movement-mechanism 140 may be in communication with the filter-receptacle 130 and configured to selectively raise and lower the filter-receptacle 130 from the bottom-side 114 of the housing. In this embodiment, the movement-mechanism 140 may be attached to the filter-receptacle 130.

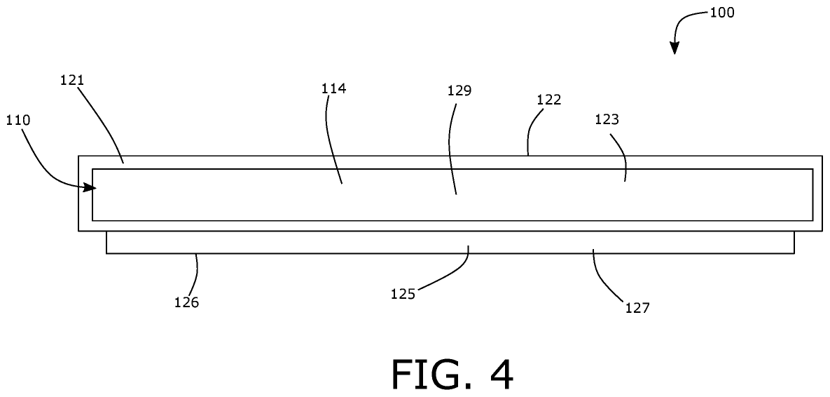

In some embodiments, the bottom-side 114 of the rear-section 121 of the housing 110 may include an opening 129 (FIG. 4) for permitting entrance and exit of the filter-receptacle 130. When the filter-receptacle 130 is installed in the housing 110, a bottom 135 of the filter-receptacle 130 may seal the opening 129. Further, whilst it is preferred that the filter-receptacle 130 is selectively raised and lowered from the bottom-side 114 of the housing 110, it should be appreciated that in some embodiments the filter-receptacle 130 may be removed from another side (112, 116, 118) of the housing 110.

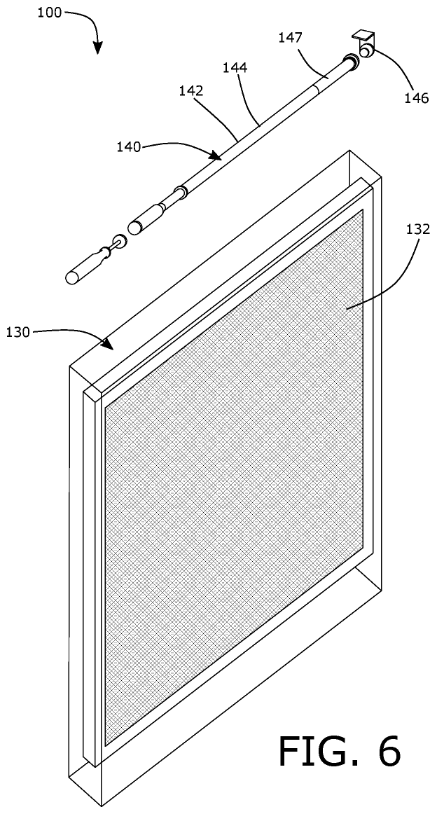

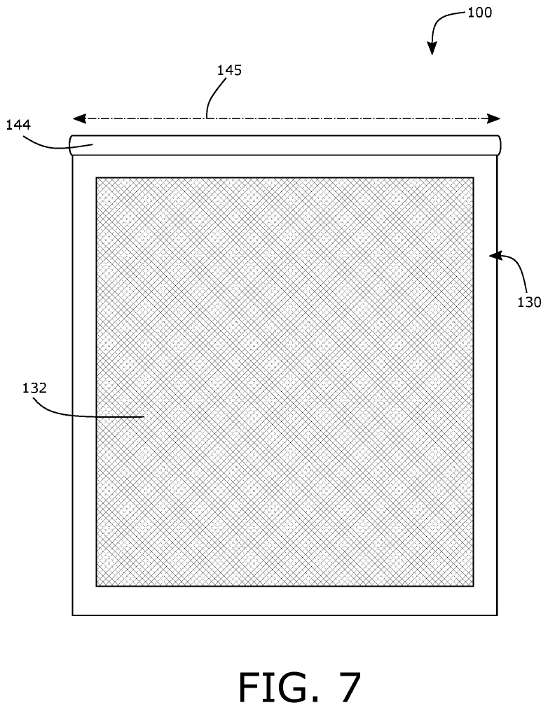

As shown specifically in FIGS. 6-8, in some embodiments, the movement-mechanism 140 may include a roller-assembly 142. The roller-assembly 142 may include a horizontal roller-rod 144 being configured for rotation about a horizontal-axis 145 (FIG. 7) (the horizontal-axis 145 being relative to the wall surface 10 and a floor surface). In some embodiments, the horizontal roller-rod 144 may be attached to the filter-receptacle 130 such that a pulling force exerted on the filter-receptacle 130 selectively lowers the filter-receptacle 130 from the bottom-side 114 of the housing. For example, a portion of the filter-receptacle 130 may be wound or folded around the horizontal roller-rod 144, the filter-receptacle 130 may include a rope wound or folded around the horizontal roller-rod 144, etc.

The movement-mechanism 140 may further include at least one gear assembly 146. In some embodiments, the at least one gear assembly 146 may include a ratchet having an integral gear. Further, a pin may be included for engaging with, and locking, the integral gear. The at least one gear assembly 146 may be attached to the horizontal roller-rod 144 or housed therewithin. The at least one gear assembly 146 may be configured to control the raising and lowering of the filter-receptacle 130 and prevent excessive raising/lowering thereof, and/or excessive speed thereof.

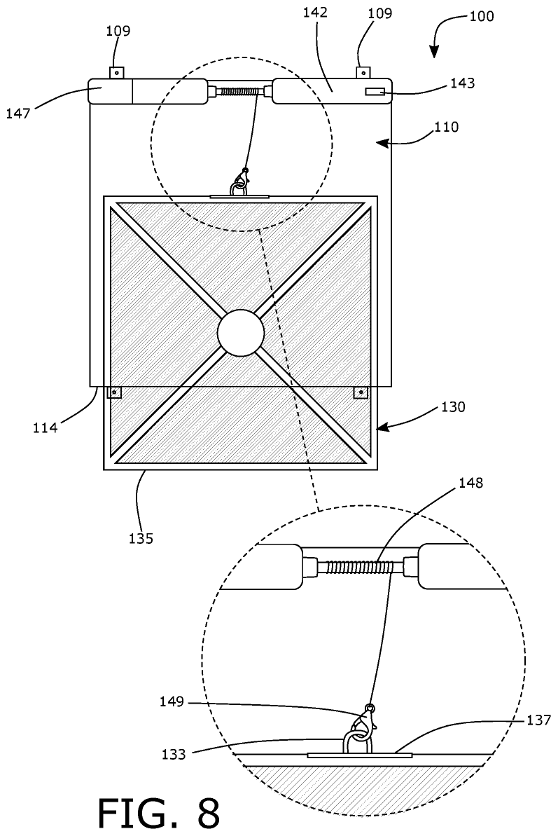

Further, in some embodiments, the roller-assembly 142 may include at least one spring 148 as shown in FIG. 8. In this embodiment, the roller-assembly 142 may include a clip-fastener 149 attached to one end of the at least one spring 148, and the filter-receptacle 130 may include a ring-fastener 133. The clip-fastener 149 may be configured to clip to the ring-fastener 133 to attach the filter-receptacle 130 to the roller-assembly 142 and enable raising/lowering of the filter-receptacle 130 from the housing 110. Further, the filter-receptacle 130 may include a reinforced-section 137. As shown, the ring-fastener 133 may be attached to the reinforced-section 137. The reinforced-section 137 may provide support to the filter-receptacle 130 when being lifted and lowered such that the filter-receptacle 130 may not bend if excessive force is applied.

The at least one spring 148 may be configured to hold the filter-receptacle 130 in a raised position (whereby the filter-receptacle 130 is secured within the housing 110). The pulling force, along with the at least one gear assembly 146 and pin may counteract a bias of the at least one spring 148 so that a user is able to lower the filter-receptacle 130. The at least one gear assembly 146 and pin may then “lock” the filter-receptacle 130 in a desired lowered position. In some examples of this embodiment, the horizontal roller-rod 144 may include a set of components for facilitating rotation thereof, such as a spring accumulator, a connector rod, etc.

In some embodiments, the roller-assembly 142 may be manually actuated. For example, the filter-receptacle 130 may be selectively lowered manually by the user by pulling (downward) on the filter-receptacle 130 (the “pulling force”) and locked into the desired lowered position by the at least one gear assembly 146 and pin. The filter-receptacle 130 may then be selectively raised manually by the user by pushing (upward) on the filter-receptacle 130.

Alternatively, or in addition to this, in embodiments including the at least one spring 148 configured to hold the filter-receptacle 130 in a raised position, the user may disengage the at least one gear assembly 146 and pin, thereby allowing the tension held in the at least one spring 148 to raise the filter-receptacle 130 into the housing 110. Further, in this embodiment, the roller-assembly 142 may include a handle or cord means (not illustrated). For example, the roller-assembly 142 may include a cord in communication with the at least one gear assembly 146. In another example, the filter-receptacle 130 may include a handle for assisting in the manual pulling thereof.

In additional embodiments, the roller-assembly 142 may be automatically actuated. In this embodiment, the movement-mechanism 140 may include at least one motor 147. The at least one motor 147 may be disposed within the horizontal roller-rod 144 and configured to automatically actuate raising and lowering of the filter-receptacle 130. In some embodiments, the at least one motor 147 may be triggered via a switch. In other embodiments, the at least one motor 147 may be triggered via a remote control. In this embodiment, the roller-assembly 142 may include a receiver for receiving a signal from the remote control. In other embodiments, the at least one motor 147 may be activated via at least one sensor. In this embodiment, the roller-assembly 142 may include the at least one sensor, a controller for facilitating communication between the at least one motor 147 and the at least one sensor, and a power source 143. For example, the power source may include batteries. For example, AA batteries. In this embodiment, at least a portion of the front-section 125 may be removable from the housing 110 to enable a user to easily change the batteries when needed. In some examples, the rear-section 121 and the front-section 125 may each include at least one bracket-means 109 (FIG. 8) configured to receive screws therethrough.

It should be appreciated that the at least one gear assembly 146 is not limited for use with the roller-assembly 142, and It should also be appreciated that the movement-mechanism 140 is not limited to the roller-assembly 142 discussed above. For example, in some embodiments, the movement-mechanism 140 may include a rope and gear assembly (not illustrated). The rope and gear assembly may include at least one gear and least one rope to act as a pulley system. For example, in some embodiments, the at least one gear may include the ratchet having an integral gear as discussed above. The at least one rope may be a thin metal rope. The at least one rope may be in communication with the at least one gear and configured for movement over the at least one gear such that a pulling force exerted on the at least one rope selectively raises and lowers the filter-receptacle 130 (or just the filter-means 132 in some embodiments) from the bottom-side 114 of the housing 110.

For example, in some embodiments, the at least one rope may be threaded, at one end, into the ratchet, thus placing it in communication with the integral gear. At an opposite end, the at least one rope may be attached to the filter-receptacle. As such, when a user pulls on the one end of the at least one rope, the movement of the at least one rope about the at least one gear may raise or lower the filter-receptacle, as the gear is driven to rotational movement by the pulling force exerted on the at least one rope.

In other embodiments, the filter-receptacle 130 (or filter-means 132) may include a tooth or other protrusion (not illustrated) configured for engaging teeth of the at least one gear assembly 146, thereby facilitating up and down movement of the filter-receptacle 130 or filter-means 132. In other embodiments still, the housing 110 may include a track-assembly (not illustrated) and the filter-receptacle 130 or filter-means 132 may include a means of engaging with the track-assembly to facilitate the up and down movement of the filter-receptacle 130 or filter-means 132.

As shown in FIGS. 7-11B, the filter-receptacle 130 may further include a lock-mechanism 134 and the air purification system 100 may include a key means 150 configured for selectively unlocking and locking the lock-mechanism 134. The lock-mechanism 134 may preferably be located at the bottom of the filter-receptacle 130. The lock-mechanism 134 may be configured to lock the filter-means 132 within the filter-receptacle 130. Alternatively, or in addition to this, the lock-mechanism 134 may be configured to lock the filter-receptacle 130 within the housing 110. In other embodiments, the lock-mechanism 134 may be located at the bottom-side 114 of the housing 110 at the rear-section 121.

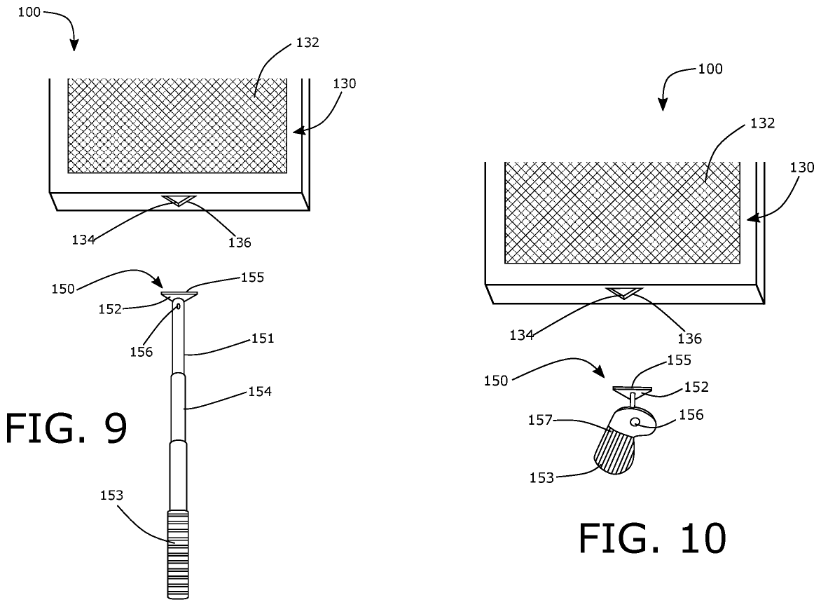

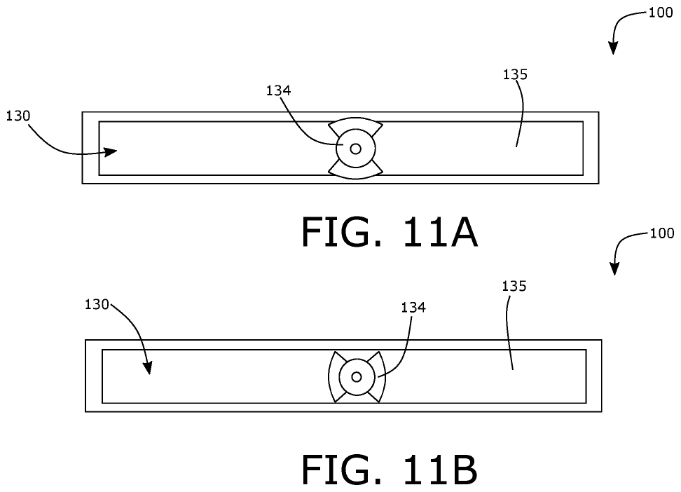

As FIG. 9 shows, the key-means 150 may include a pole 151 having a key-end 152, a handle-end 153 and an elongated shaft 154 therebetween. The key-end 152 may include a male-protrusion 155, and the lock-mechanism 134 may include a female-groove 136 located on an outer-surface of the bottom 135 of the filter-receptacle 130. As such, the male-protrusion 155 at the key-end 152 may be configured to mate with the female-groove 136 and selectively lock and unlock the lock-mechanism 134. For example, when the lock-mechanism 134 is locked, as shown in FIG. 11A, the user may insert the key-end 152 into the female-groove 136 of the lock-mechanism 134 and twist approximately 90 degrees to open the lock-mechanism 134 as shown in FIG. 11B. In some embodiments, again as shown in FIGS. 9-10, the female-groove 136 and the male-protrusion 155 may be triangular-shaped. However, it should be appreciated that the female-groove 136 and the male-protrusion 155 are not limited to this shape. It should also be appreciated that the lock-mechanism 134 is not limited to the configuration shown in FIGS. 11A-11B.

The elongated shaft 154 of the pole 151 may allow the user to easily reach the lock-mechanism 134 therewith. This may be particularly useful for vents that are located high on the wall surface 10. The elongated shaft 154 may be extendable. Preferably, the elongated shaft 154 may be telescopic. In some embodiments, as shown in FIG. 10, the key-means 150 may not include the pole 151 or the elongated shaft 154. This may be useful in situations where the vent is not located high on the wall surface 10. As shown, in this embodiment, the key-means 150 may include just the key-end 152, the handle-end 153 and a body 157 therebetween. The key-end 152 may be selectively stowable in the body 157. Further, to aid in easy unlocking and locking of the lock-mechanism 134, the key-means 150 may include at least one light source 156. In some examples, the at least one light source 156 may be at least one light emitting diode (LED). The at least one light source 156 may be located about the key-end 152 of the key-means 150 and configured to illuminate the female-groove 136 of the lock-mechanism 134 when the key-end 152 is near thereto.

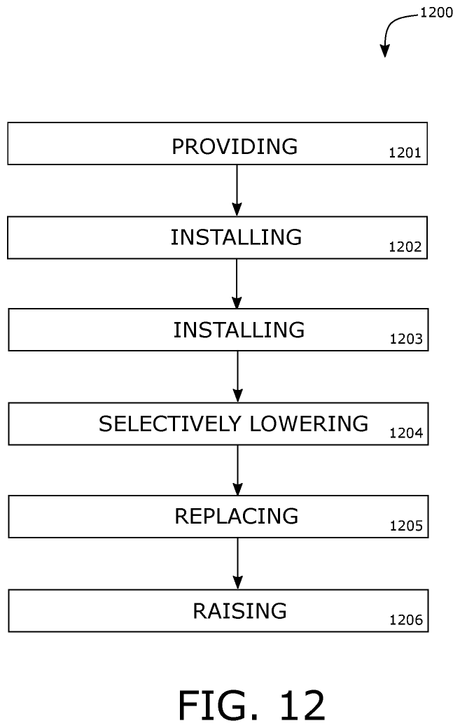

Referring now to FIG. 12 showing a flow diagram illustrating a method of use 1200 for an air purification system, according to an embodiment of the present disclosure. In particular, the method of use 1200 may include one or more components or features of the air purification system 100 as described above. As illustrated, the method of use 1200 may include the steps of: step one 1201, providing the air purification system as above; step two 1202, installing the filter-means in the filter-compartment of the rear-section; and step three 1203, installing the housing over the vent, the rear-side being placed thereover to receive the moving airflow such that the filter-means is able to filter the moving airflow before being vented into the room.

Further steps may include the changing of the filter-means as discussed above. These further steps may include step four 1204, selectively lowering the filter-means from the filter-compartment via the movement-mechanism, as needed (for example when the filter-means becomes clogged); step five 1205, replacing the filter-means with another filter-means; and step six 1206, raising the ‘another’ filter-means into the filter-compartment via the movement-mechanism. Further, in some embodiments, instead of the replacing the filter-means with another filter-means, the filter-means may be cleaned and placed back into the filter-compartment/filter-receptacle.

It should be noted that steps four (1204), five (1205) and six (1206) are optional steps and may not be implemented in all cases. Optional steps of method of use 1200 are illustrated using dotted lines in FIG. 12 so as to distinguish them from the other steps of method of use 1200. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for purifying and filtering moving airflow received from a vent of a building are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An air purification system for installation over a vent, the vent being integral to a wall surface in a room of a building, the vent configured to vent moving airflow conveyed from ductwork in an air system of the building, the air purification system comprising:
a housing including a top-side opposite a bottom-side, a right-side opposite a left-side and a front-side opposite a rear-side all relative to the wail surface, the front-side being substantially open, the rear-side being configured for placement over the vent and thus configured to receive the moving airflow, the housing being defined by:
a rear-section relative to the rear-side, the rear-section including a filter-compartment configured to removably house a filter-means, the filter-means configured to filter particles from the moving airflow; and
a front-section relative to the front-side, the front-section including a set of horizontal-slats, each of the horizontal-slats being angled to let filtered said airflow through the front-side of the housing and into the room of the building; and
a movement-mechanism in communication with the filter-compartment and configured to selectively raise and lower the filter-means from bottom-side of the housing.

2. The air purification system of claim 1, further comprising a filter-receptacle removably received within the filter-compartment, the filter-receptacle being configured to removably house the filter-means.

3. The air purification system of claim 2, wherein the filter-means is a High-Efficiency Particulate Air (HEPA) filter.

4. The air purification system of claim 1, wherein the movement-mechanism is in communication with the filter-receptacle and configured to selectively raise and lower the filter-receptacle from the bottom-side of the housing.

5. The air purification system of claim 1, wherein the movement-mechanism includes a roller-assembly, wherein the roller-assembly includes a horizontal roller-rod being configured for rotation about a horizontal-axis, and wherein the horizontal roller-rod is attached to the filter-receptacle such a pulling force exerted on the filter-receptacle selectively lowers the filter-receptacle from the bottom-side of the housing.

6. The air purification system of claim 4, wherein the movement-mechanism further includes at least one gear assembly.

7. The air purification system of claim 6, wherein the movement-mechanism further includes at least one motor.

8. The air purification system of claim 1, wherein the front-section and the rear-section of the housing are separable.

9. The air purification system of claim 1, wherein the filter-receptacle includes a lock-mechanism.

10. The air purification system of claim 9, wherein the lock-mechanism includes a female-groove located on an outer-surface of a bottom of the filter-receptacle.

11. The air purification system of claim 10, further comprising a key-means configured for selectively unlocking and locking the lock-mechanism.

12. The air purification system of claim 11, wherein the key-means includes a pole having a key-end, a handle-end and an elongated shaft therebetween, the key-end comprising a male-protrusion configured to mate with the female-groove and selectively lock and unlock the lock-mechanism.

13. The air purification system of claim 21, wherein the key-means includes at least one light source.

14. The air purification system of claim 1, wherein the rear-section includes a rear section-depth of between 0.75-1 inch.

15. An air purification system for installation over a vent, the vent being integral to a wall surface in a room of a building, the vent configured to guide moving airflow conveyed from ductwork in a air system of the building, the air purification system comprising:
a housing including a top-side opposite a bottom-side, a right-side opposite a left-side and a front-side opposite a rear-side all relative to the wall surface, the front-side being substantially open, the rear-side being configured for placement over the vent and thus configured to receive the moving airflow, the housing being defined by:
a rear-section relative to the rear-side, the rear-section including a filter-compartment, the filter-compartment being configured to removably receive a filter-receptacle, the filter-receptacle including a lock-mechanism having a female-groove located on an outer-surface of a bottom thereof, the filter-receptacle being configured to removably house a High-Efficiency Particulate Air (HEPA) filter, the HEPA filter configured to filter particles from the moving airflow; and
a front-section relative to the front-side, the front-section including a set of horizontal-slats, each of the horizontal-slats being angled to let filtered airflow through the front-side of the housing and into the room of the building;
a movement-mechanism in communication with the filter-receptacle and configured to selectively raise and lower the filter-receptacle from bottom-side of the housing; and
a key-means configured for selectively unlocking and locking the lock-mechanism, the key-means including a pole having a key-end, a handle-end and an elongated shall therebetween, the key-end including a male-protrusion configured to mate with the female-groove and selectively lock and unlock the lock-mechanism, the key-means further including at least one light source.

16. The air purification system of claim 15, wherein the movement-mechanism includes a roller-assembly, wherein the roller-assembly includes a horizontal roller-rod being configured for rotation about a horizontal-axis, and wherein the horizontal roller-rod is attached to the filter-receptacle such a pulling force exerted on the filter-receptacle selectively lowers the filter-receptacle from the bottom-side of the housing.

17. The air purification system of claim 16, wherein the movement-mechanism further includes at least one gear assembly.

18. The air purification system of claim 17, wherein the movement-mechanism further includes at least one motor.

19. A method of use for an air purification system, the air purification system configured for installation over a vent, the vent being integral to a wall surface in a room of a building, the vent configured to vent moving airflow conveyed from ductwork in a air system of the building, the method comprising the steps of:
providing the air purification system including:
a housing including a top-side opposite a bottom-side, a right-side opposite a left-side and a front-side opposite a rear-side all relative to the wall surface, the front-side being substantially open, the rear-side being configured for placement over the vent and thus configured to receive the moving airflow, the housing being defined by:
a rear-section relative to the rear-side, the rear-section including a filter-compartment configured to removably house a filter-means, the filter-means configured to filter particles from the moving airflow; and
a front-section relative to the front-side, the front-section including a set of horizontal-slats, each of the horizontal-slats being angled to let filtered airflow through the front-side of the housing and into the room of the building; and
a movement-mechanism in communication with the filter-compartment and configured to selectively raise and lower the filter-means from bottom-side of the housing;
installing the filter-means in the filter-compartment of the rear-section; and
installing the housing over the vent, the rear-side being placed thereover to receive the moving airflow such that the filter-means is able to filter the moving airflow before being vented into the room.

20. The method of claim 19, further comprising the steps of:
selectively lowering the filter-means from the filter-compartment via the movement-mechanism, as needed;
replacing the filter-means with another filter-means; and
raising said another filter-means into the filter-compartment via the movement-mechanism.
